(19) United States
(12) Patent Application Publication
(10) Pub. No.: US 2026/0359446 A1
(43) Pub. Date: Nov. 12, 2026

(54) AI-Driven Cybersecurity and Quality Analyzer for Pre-Deployment Threat Detection in Software Testing

(71) Applicant: Gopinath Kathiresan, Sunnyvale, CA (US)

(72) Inventor: Gopinath Kathiresan, Sunnyvale, CA (US)

(21) Appl. No.: 19/203,210

(22) Filed: May 9, 2025

(51) Int. Cl. G06F 21/57

(52) U.S. Cl. CPC G06F 21/577; G06F 2221/033

(57) ABSTRACT

This present invention relates to an intelligent system that enables software teams to identify security threats and quality issues in software during the pre-deployment test phase itself. By utilizing artificial intelligence, the system continuously monitors underlying processes during the testing phase such as logs and behavioral patterns, it flags anomalies, such as unauthorized API calls or suspicious user activity. This invention uniquely correlates runtime anomalies with test coverage gaps to prioritize security fixes during the QA phase. This method of software testing allows earlier bug detection and fixes saving time and cost of the software development. What makes it different is that it doesn't wait until production to check for problems. Instead, it combines security insights with testing coverage to catch vulnerabilities early, making software safer and more reliable before it reaches users.

### CROSS REFERENCES TO RELATED APPLICATION

Not applicable

### STATEMENT REGARDING FEDERALLY SPONSORED RESEARCH OR DEVELOPMENT

Not applicable

### MICROFICHE APPENDIX

Not applicable

### BACKGROUND OF THE INVENTION

### 1. Field of the Invention

The present invention is related to a software testing workflow that leverages artificial intelligence (AI) to improve the identification and analysis of security vulnerabilities and anomalies in software, prior to deployment during the Quality Assurance (QA) and software testing phase. This invention offers an enhanced AI-driven threat detection model by integrating AI-driven threat detection models to proactively identify potential exploits, anomalies, and vulnerabilities or deficiencies in application code, configuration, and dependencies.

### Description of the Related Art

In the realm of software testing and quality assurance, particularly in testing, software developers frequently face the daunting challenge of ensuring there are no quality issues and vulnerabilities in the software prior to deployment of the software, but always scramble to fix the bugs when software is deployed into production. My invention presents AI assisted method of detection of cybersecurity threats prior to deployment in the system. Conventional security tools often initiate threat monitoring only after software is deployed to production, monitoring real-time threats and attacks. Similarly, conventional QA tools primarily emphasize functionality, missing cybersecurity risks until post-deployment. In parallel, quality assurance tools primarily focus on functional correctness and regression testing without adequately addressing cybersecurity concerns. At the same time, software testing tools typically focus on detecting bugs and anomalies, ensuring thoroughness, and performance. This leaves a critical blind spot where a software may pass all QA validations yet propagate vulnerabilities into production.

Conventional cybersecurity and QA tools can be trained to find the security anomalies but are susceptible to false flags, these tools still rely on manual verification for anomaly classification between true positives and false flags which is both time-consuming and costly. Where present invention utilizes machine learning and AI to constantly learn to differentiate between real threats and false flags; while only ambiguous cases are escalated to human analysts for further evaluation.

There is a critical need for a system that combines automated security threat detection and quality assurance in the early stages of the software development life cycle (SDLC). This solution addresses a critical deficiency incurred with modern software test beds, software testing emulators, and software mutation analyzers.

### BRIEF SUMMARY OF THE INVENTION

The present invention provides an AI-based analyzer that is engineered to function during the QA stage of software development. It Ingests runtime logs from QA environments in real-time, utilizes machine learning models to detect anomalies, unauthorized access attempts, and behavioral inconsistencies then correlates these anomalies with test coverage data and software modules and outputs detailed visual reports accompanying both security risks and areas lacking adequate testing. The solution enables early mitigation of risks, enhances test coverage analysis, and improves software reliability before deployment. The system operates by utilizing machine learning and Artificial Intelligence to test the software during the testing phase itself. Furthermore, it provides actionable remediation and recommends solutions for developers to address issues, and resolve bugs, flaws, security gaps.

### BRIEF DESCRIPTION OF THE DRAWINGS

FIG. 1. is the high-level system architecture diagram of the threat detection tool.

FIG. 2. depicts the AI analysis pipeline flowchart diagram.

FIG. 3. depicts the example timeline use-case flowchart diagram.

FIG. 4. illustrates the sample dashboard flowchart diagram.

### DETAILED DESCRIPTION OF THE INVENTION

The following description illustrates embodiments of the present disclosure and ways in which they can be implemented. Although some modes of carrying out the present disclosure have been disclosed, those skilled in the art would recognize that other embodiments for carrying out or practicing the present disclosure are also possible. The method of working of the present invention is accompanied by the multiple flowchart diagrams as follows.

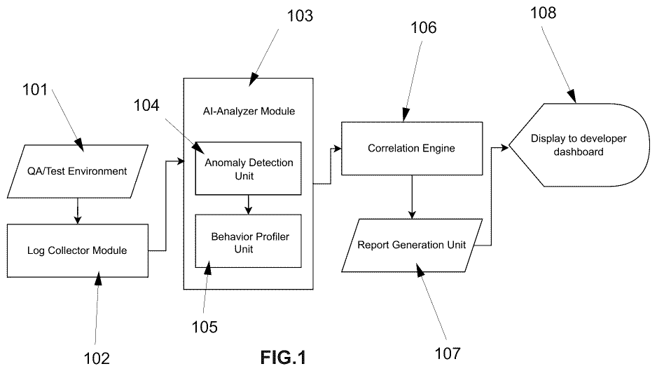

High-level system architecture is illustrated in FIG. 1. The system monitors runtime data generated during the execution of QA test cases 101 in a test environment, then data is transferred to a log collector module 102 which captures this data and passes it to a machine learning-powered analyzer. An AI analyzer module 103 is integrated with an anomaly detection unit 104, and a behavior profiling unit 105. The analyzer uses trained models to flag abnormal API requests, detect unexpected user paths, and Identify data access patterns deviating from intended workflows. These findings are matched against test coverage to determine whether certain risky paths have been sufficiently tested. Results are compiled in a developer-friendly visual report. Data from the AI analyzer is transferred to a correlation engine 106, it maps detected anomalies for specific software components and tests coverage data to identify untested or vulnerable areas. The test report is generated specifying all anomalies and quality issues at the report generation unit 107. Generated report is further transferred to end-user presentation on visual developer dashboard 108.

The subsequent operation in the workflow is to share the log data and test metadata to the threat analysis pipeline and generate a threat score which subsequently will be used to determine the severity of the threat and compute a risk score, which is a key component to determine appropriate remediation actions based on a calculated threat score. The benefit of doing threat scoring is, it improves the accuracy of risk assessments and enables real-time monitoring and keeps risk scores updated. Threat Score is computed as the arithmetic product of two constituent variables, Likelihood, and Impact i.e “Threat Score=Likelihood×Impact”, where the term Likelihood is the probability that a given threat will be exploited, and impact is the potential damage or consequences if the threat is successfully exploited. In present system both Likelihood and Impact are rated on a numerical scale between 1 to 10; the resultant threat score is rated on a scale 1 to 100, with higher values indicating higher chances of exploitation. If the evaluated threat score is above the 80-point threshold, it will be counted as a critical risk level and it might automatically fail the continuous integration/continuous deployment (CI/CD) pipeline.

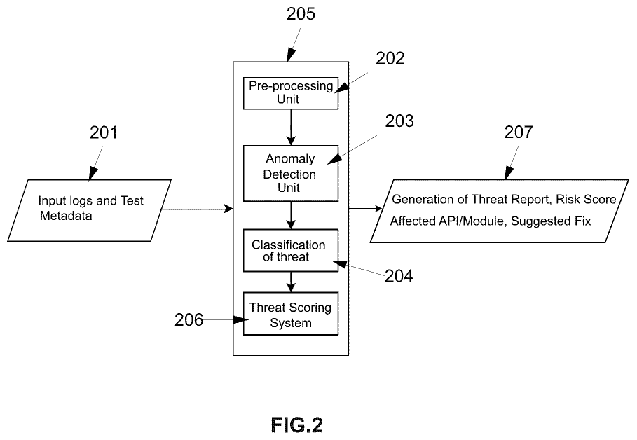

AI analysis pipeline flowchart diagram is demonstrated in FIG. 2, the system monitors input logs and test metadata 201, generated during the execution of QA test cases and computes threat scores. The system integrates threat filtration and grading module 205, this module comprises several steps to achieve a threat score as depicted. Threats are then transferred to pre-processing unit 202 to differentiate between regular events and detected anomalies. The anomaly detection unit 203 detects the anomaly and figures out if the anomaly is a threat or a false alarm. Successfully detected anomaly is then transferred for threat classification module 204, here threats are classified and sent to threat scoring system 206, based on the formula “Threat Score=Likelihood×Impact” and threat scoring is completed to assign a risk value to each detected anomaly based on its severity, likelihood, and potential impact. Finally, the Threat report is generated as illustrated 207. This module can incorporate models of unsupervised learning algorithms like isolation forest and K-Means clustering to identify unknown threats; behavior profiling models to learn normal user and system behavior during test runs; and time-series models to monitor deviations across test cycles. These models are continuously updated using historical tests and production data to adapt overtime. For anomaly detection the most commonly employed algorithms are Isolation Forest and K-means clustering algorithms, the method of working of each is further discussed as follows in association with the present invention.

Isolation Forest algorithm is an unsupervised anomaly detection algorithm renowned for its efficiency and versatility, particularly well-suited for identifying abnormal data points in high-dimensional datasets. Isolation Forest takes a unique approach by randomly selecting features and splitting them along random values until individual data points are isolated. It works by taking the input dataset and splitting it into two branches, labeled “Normal with uncommon” and “Outliers.” The “Normal with uncommon” branch keeps splitting until it reaches the label of “Normal.” The “Outliers” branch arrives at the “Outliers” label more rapidly. This approach is highly effective for detecting outliers like sudden spikes in error rates and unusual session duration. Isolation Forest is trained in an unsupervised manner using historical QA logs or system activity data without requiring any labeled data for training.

The k-means clustering algorithm is another popular unsupervised machine learning algorithm that groups data points into “k” clusters based on their similarity. The algorithm works by first randomly picking some central points called centroids, and each data point is then assigned to the closest centroid forming a cluster. Once all points are assigned, the centroids are recalculated as the mean of the points within each cluster. This process continues until the centroids stabilize or a specified number of iterations is reached, indicating that the algorithm has converged. K-means is commonly used in tasks like customer segmentation, image processing, anomaly detection, and pattern recognition. These algorithms use features like API call frequency, session duration, response time anomalies, error rates, User login frequency, and device type to group similar behaviors, helping QA teams identify usage patterns, detect patterns, and monitor changes over time.

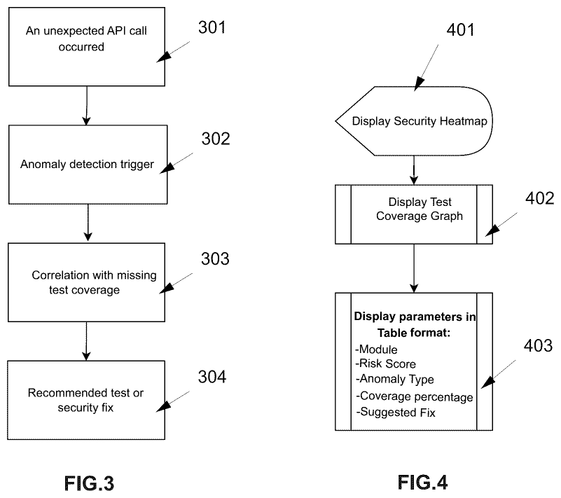

An example case scenario during the testing of software using the present invention is depicted in FIG. 3. As the flowchart depicts, if an unexpected API call 301 occurs, it will trigger the anomaly detection module 302 to identify irregular or unexpected patterns in test data; The resulting data is subsequently forwarded to the correlation with missing test coverage module 303, which identifies potential undetected bugs and untested edge cases. Based on this analysis, the system then recommends targeted tests and security fixes 304 for the detected anomalies. This process is instrumental for mitigating potential blind spots within the testing pipeline.

A relevant use case is observed when a regression test accidentally invokes an internal endpoint without proper authentication. Test logs expose sensitive user data, a user session escalates permissions without corresponding login events. Each of these cases is detected and flagged before the software moves to production. Furthermore, the practical use case of anomaly detection is described as follows.

The present invention demonstrates a robust use case in the banking sector. A bank that has deployed a rules-based fraud detection system, on average only had a 40% success rate to detect the real fraud and created 1,400 false positives each day. Furthermore, the bank found that 99.5 percent of suspicious cases it investigated were not fraudulent. These ineffective inquiries consumed time and resources that may be better spent dealing with true fraud. If this Bank deploys present technology that improves fraud detection by 60% while lowering false positives by 70%. Many choices were likewise automated, nonetheless, some scenarios required manual review by human analysts. Every case manually reviewed triggers a new learning pattern so the system next time will be able to handle the same threat without requiring any human intervention.

The Healthcare industry presents a practical and impactful use case for the present invention too. A wearable device equipped for heart rate monitoring and fall detection automatically alerts the appropriate contact upon detecting abrupt heart rate fluctuations or a fall event. By evaluating the data of such companies turns out that most of the heart rate alarms and falls detected were not serious but just anomalies. The present invention can be integrated with wearable devices to continuously learn individual-specific anomalies, enabling it to detect potential threats and issue emergency alerts to designated individuals. Furthermore, it incorporates feedback from the concerned person that detected anomaly was a real threat or false flag, helping to reduce false alarms to a minimum.

A viable implementation of the present invention can be realized in the Telecommunication sector. The present invention can be implemented to assess the authenticity of flagged spam callers based on user-generated reports. In mobile networks, scam callers frequently engage in persistent spamming behavior, leading users to report and block them. However, some users also flag legitimate service providers such as delivery agents or insurance companies as spam. Consequently, these essential services may become unable to contact their customers. Present invention can be paired with voice analytics tools to detect the spammers and genuine callers, which contribute to differentiating between genuine callers and actual scammers, thereby reducing false positives and ensuring uninterrupted communication for legitimate entities.

The sample dashboard, as illustrated in FIG. 4, visualization of a security heat map of the identified issues is a primary component of the insight and reporting, the developer dashboard visually represents a security heat map 401 indicating the severity of the threat, and visual test coverage graph 402 is also visually represent for developer which renders the risk ranked list of issues, including type of anomaly such as injection and unauthorized access; related test case modules; level of test coverage which indicates how thoroughly the software's code or components have been exercised by test cases, helping identify untested or under-tested areas; then system suggests additional test scenarios or mitigation actions to address detected risks. The report is generated in table format 403, visually rendering the compromised module, risk score, anomaly type, coverage percentage, and fix suggestions. This report is fully adaptable and engineered to support streamlined integration with CI/CD pipelines. Such integration facilitates the automated generation and distribution of the report during build and deployment processes, providing developers with real-time, actionable security and quality insights to facilitate early intervention. If a critical issue is detected and cannot be resolved automatically, the tool can block the deployment to prevent unstable or faulty code from reaching production.

The dashboard as illustrated in FIG. 4 also facilitates role-based customization by users or teams. Security, QA, and DevOps individuals or teams can modify the user interface and parameters to meet their requirements of user or team-specific workflows. The present tool is also highly modular, configurable, and adaptable for integration with third party cybersecurity and external vulnerability management tools. Third-party software can be integrated with the API of this tool for seamless integration with the existing parameters.

The Present Invention is further configured to support integration with continuous model retraining. Continuous model retraining, also known as continuous training(CT) is the process of automatically retraining and serving machine learning models in production, therefore this tool can be used to detect anomalies and bugs in real-time too. This feature enables the possibility of utilization of capabilities of the current software system in production too, keeping the software not limited to mere testing scenarios.

What is claimed is:

1. A method for detecting cybersecurity and quality assurance-related anomalies during software testing, comprising the following four steps:
(a) the first step of collecting runtime logs generated while software testing;
(b) the second step of analyzing the logs using one or more machine learning models to identify anomalies;
(c) the third step of correlating detected anomalies with software quality metrics and test coverage data; and
(d) final step of generating a report identifying potential security risks and test gaps prior to deployment.

2. The method of claim 1, wherein the machine learning models comprising unsupervised anomaly detection and behavioral profiling unit.

3. The method of claim 1, wherein the anomalies are mapped to application components or APIs with insufficient test coverage.

4. The method of claim 1, wherein the report categorizes each risk by severity, the likelihood of exploitation, and affected modules.

5. A system of detecting cybersecurity and quality assurance-related issues during the test phase of the software development, comprising:
(a) a log collector module configured to receive runtime logs generated during the test phase;
(b) an analysis engine comprising an anomaly detection unit and behavioral profiling module;
(c) a correlation engine to associate anomalies with test coverage; and
(d) a report generator configured to presents the results via a graphical user interface, a report identifying cybersecurity risks, and quality-related issues.
